(19) United States
(12) Patent Application Publication
(10) Pub. No.: US 2015/0130183 A1
(43) Pub. Date: May 14, 2015

(54) DOUBLE WALL TUBE ADAPTER AND JOINT

(71) Applicant: EATON CORPORATION, Cleveland, OH (US)

(72) Inventors: Richard L. Statler, III, Denver, CO (US); David W. Struckman, Westminster, CO (US); Clifton Breay, Littleton, CO (US); Jon Neal, Denver, CO (US); David Woolard, Woodfin, NC (US); Jay Caudill, Westminster, CO (US)

(73) Assignee: EATON CORPORATION, Cleveland, OH (US)

(21) Appl. No.: 14/350,208

(22) PCT Filed: Oct. 5, 2012
(86) PCT No.: PCT/US12/58865

§ 371 Date: Apr. 7, 2014

Related U.S. Application Data
(60) Provisional application No. 61/544,342, filed on Oct. 7, 2011.

(51) Int. Cl. F16L 39/00; B23K 20/00; B23K 20/12; B25B 5/14; B23P 11/00

(52) U.S. Cl. CPC F16L 39/005; B25B 5/147; B23P 11/005; B23K 20/129; B23K 20/002
USPC 285/123.15; 29/428; 29/509; 29/525.08; 228/107; 228/101

(57) ABSTRACT

A joint for a double wall tube assembly includes an adapter having an inner wall and an outer wall connected by a web, and a flange extending from the outer wall. The inner wall is configured to receive an inner tube of a double wall tube assembly. The outer wall is configured to be connected to an outer tube of the double wall tube assembly.

### FIELD OF INVENTION

The present disclosure relates to the field of double wall tubing systems. More particularly, the present disclosure relates to an adapter and joint for double wall tubing systems.

### BACKGROUND

Double wall tubing systems (also referred to as coaxial tubing systems) may be used to convey fluid from one location to another. Double wall tubing systems include an inner tube and an outer tube, and may further include a sleeve or other material disposed between the inner tube and the outer tube. In one known embodiment, fluid is conveyed through the inner tube, while the outer tube contains any fluid that escapes the inner tube. While a double wall tubing system may be used to convey any fluid, it is particularly useful for conveying fuel, hazardous liquids, toxic gasses, hot air, cold air, waste water, or drinking water. Double wall tubing systems are commercially available with a variety of different inner diameters and outer diameters.

In other known embodiments, double wall tubes are employed to provide dual fluid flow paths, where a first fluid is conveyed in a first direction in the inner tube and a second fluid is conveyed in an opposite direction in the outer tube. Double wall tubes may also be employed to provide a thermal interface for fluid flow (i.e., as a heat exchanger).

### SUMMARY OF THE INVENTION

In one embodiment, a joint for a double wall tube assembly includes an adapter having an inner wall and an outer wall connected by a web, and a flange extending from the outer wall. The inner wall is configured to receive an inner tube of a double wall tube assembly. The outer wall is configured to be connected to an outer tube of the double wall tube assembly.

In another embodiment, an adapter for a double wall tube assembly includes a first end defined by a first wall having a first diameter, wherein the first wall is configured to receive an inner tube of a double wall tube assembly. The adapter further includes a second end defined by a second wall having a second diameter greater than the first diameter, wherein the second wall is configured to be connected to an outer tube of the double wall tube assembly. The second wall flares outward towards the first end, thereby defining a third diameter portion. The third diameter is greater than the first diameter and greater than the second diameter. The adapter further includes a web connecting the first wall to the second wall.

In yet another embodiment, a method of joining a double wall tube assembly includes providing an adapter having an inner wall, an outer wall, and a flange extending from the outer wall, with a webbing connecting the inner wall to the outer wall. The method further includes connecting an inner tube of the double wall tube assembly to the inner wall of the adapter. The method also includes connecting an outer tube of the double wall tube assembly to the outer wall of the adapter.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a front view of one embodiment of an adapter 100;

FIG. 2 is a side view of the adapter 100 of FIG. 1;

FIG. 3 is a perspective view of the adapter 100 of FIG. 1;

FIG. 4 is a cross section of the adapter 100 of FIG. 1;

FIG. 5 is a cross section of one embodiment of an adapter, illustrating sections of different material composition;

FIG. 6 is a cross section of an alternative embodiment of an adapter, illustrating sections of different material composition;

FIG. 7 is a cross section of an exemplary double wall tube;

FIG. 8 is a cross section of one embodiment of an inner ferrule;

FIG. 9 is a cross section of one embodiment of an outer ferrule;

FIG. 10 is a side view of one embodiment of a partial joint assembly 500 of a double wall tube;

FIG. 11 is a cross section of the partial joint assembly 500 of FIG. 10;

FIG. 12 is a front view of the partial joint assembly 500 of FIG. 10;

FIG. 13 is a perspective view of the partial joint assembly 500 of FIG. 10;

FIG. 14 is a side view of one embodiment of a joint assembly 600 of a double wall tube;

FIG. 15 is a cross section of the joint assembly 600 of FIG. 14;

FIG. 16 is a perspective view of an alternative embodiment of an adapter 700;

FIG. 17 is a front view of the adapter 700 of FIG. 16;

FIG. 18 is a cross section of the adapter 700 of FIG. 16;

FIG. 19 is a cross section of an adapter, illustrating sections of different material composition; and

FIG. 20 is a cross section of an adapter, illustrating sections of different material composition.

### DETAILED DESCRIPTION

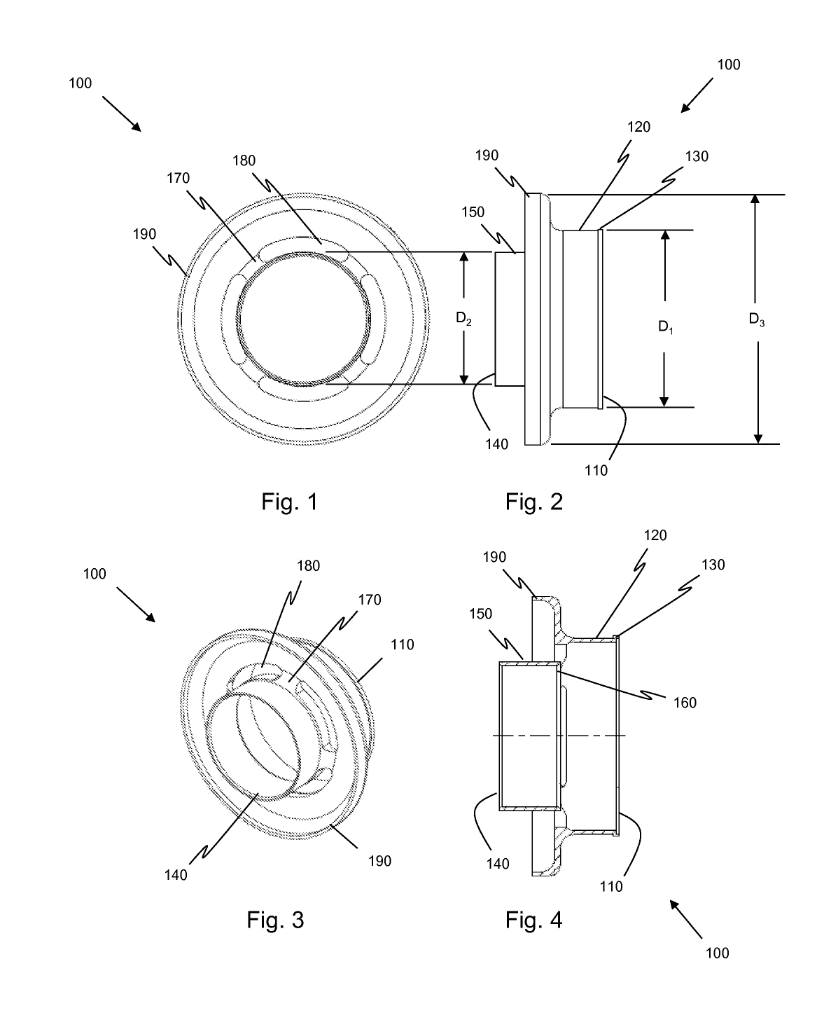

FIGS. 1 and 2 illustrate front and side views, respectively, of one embodiment of an adapter 100 for a double wall tube. FIGS. 3 and 4 illustrate a perspective view and cross section of the adapter 100. The adapter 100 is described herein with reference to all of FIGS. 1-4.

The adapter 100 has a large end 110 defined by an outer wall 120 having a first diameter D₁. The large end 110 is configured to receive an outer tube of a double wall tube. In one embodiment, the first diameter D₁ is between 0.5 inches (1 cm) and 7 inches (18 cm). In an alternative embodiment, the first diameter D₁ is between 1 inch (2 cm) and 2 inches (5 cm). However, it should be understood that the large end 110 may be sized to receive the outer tube of any double wall tube.

In the illustrated embodiment, the large end 110 has a rim 130 about the outer wall 120 that receives an outer tube of a double wall tube. In an alternative embodiment (not shown), the rim may be omitted.

The adapter 100 also has a small end 140 defined by an inner wall 150 having a second diameter D₂. The inner wall 150 is configured to receive an inner tube of a double wall tube. In one embodiment, the second diameter D₂ is between 0.1 inches (0.3 cm) and 6.5 inches (16.5 cm). In an alternative embodiment, the second diameter D₂ is between 0.5 inches (1 cm) and 1.5 inches (4 cm). However, it should be understood that the inner wall 150 may be sized to receive the inner tube of any double wall tube.

In the illustrated embodiment, the inner wall 150 of the small end 140 is smooth. In an alternative embodiment (not shown), the small end may include an internal rim about the inner wall that receives an inner tube.

The inner wall terminates at an inner end 160. In the illustrated embodiment, the inner wall 150 is smooth at the inner end 160. In an alternative embodiment (not shown), the inner wall includes an internal rim about the inner end.

The outer wall 120 is connected to the inner wall 140 by a web 170. In the illustrated embodiment, the web 170 is connected to the inner end 160 of the inner wall 150. In an alternative embodiment (not shown), the inner wall 150 has a greater length such that the web 170 is spaced from the inner end 160.

The web 170 has a plurality of elongated vents 180 proximal to the inner wall 140. Placing the vents 180 proximal to the inner wall 140 may prevent entrapment of fuel that escapes from the inner tube of a double wall tube. In an alternative embodiment (not shown), the vents may be spaced from the inner wall. In another alternative embodiment (not shown), the events may be circular, square, rectangular, or take the form of any geometric shape. In yet another alternative embodiment (not shown), the web is solid. A solid web may create a containment area in a joint between a double wall tube and a single wall tube.

The adapter 100 further includes an outer flange 190 that is configured to receive an outer ferrule. The outer flange 190 has a third diameter D₃. In one embodiment, the third diameter D₃ is between 0.5 inches (1 cm) and 7 inches (18 cm). In an alternative embodiment, the third diameter D₃ is between 1.5 inches (4 cm) and 2.5 inches (6.5 cm). However, it should be understood that the outer flange 190 may be sized to receive any outer ferrule.

The outer flange 190 extends outward from the outer wall 120. In the illustrated embodiment, the outer flange 190 is located at substantially the same distance from the large end 110 as the web 170. In an alternative embodiment (not shown), the outer flange may be closer to the large end than the web. In another alternative embodiment (not shown), the outer flange may be closer to the small end than the web.

In one embodiment, the adapter 100 is a unitary component that is machined from a single material. In alternative embodiments, the adapter 100 may be molded or cold formed. In another alternative embodiment, the components of the adapter may be made separately, and then assembled. In such an embodiment, the components may be affixed by an adhesive, by welding, by crimping, by swaging, or by a friction fit. In such an embodiment, the components may be constructed of different materials.

In one known embodiment, the adapter 100 is constructed of steel. In alternative embodiments, the adapter may be constructed of titanium, aluminum, copper, or any other metal. In another alternative embodiment, the adapter may be constructed of a ceramic or polymeric material.

In one particular embodiment, the adapter 100 is manufactured from a bimetallic block or a bimetallic rod. The bimetallic block or rod can be manufactured by explosion welding two or more sheets or blocks of metal together, such as a block of aluminum to a block of steel. In another embodiment the bimetallic block or rod can be manufactured by friction welding two or more sheets or blocks of metal together, such as a block of aluminum to a block of steel. The materials may be selected to correspond to the materials of a double wall tube, thereby allowing the outer wall of the adapter to be welded to an outer wall of a double wall tube, and further allowing the inner wall of the adapter to be welded to an inner wall of a double wall tube.

In the bimetallic block or bimetallic rod, transition layers of dissimilar metals, such as tantalum, titanium, or copper may be used between the aluminum and steel layers. The transition layers provide barrier between dissimilar metals that prevent galvanic corrosion and improve the strength of the resulting explosion welded material. It should be understood that many other combinations of materials are possible.

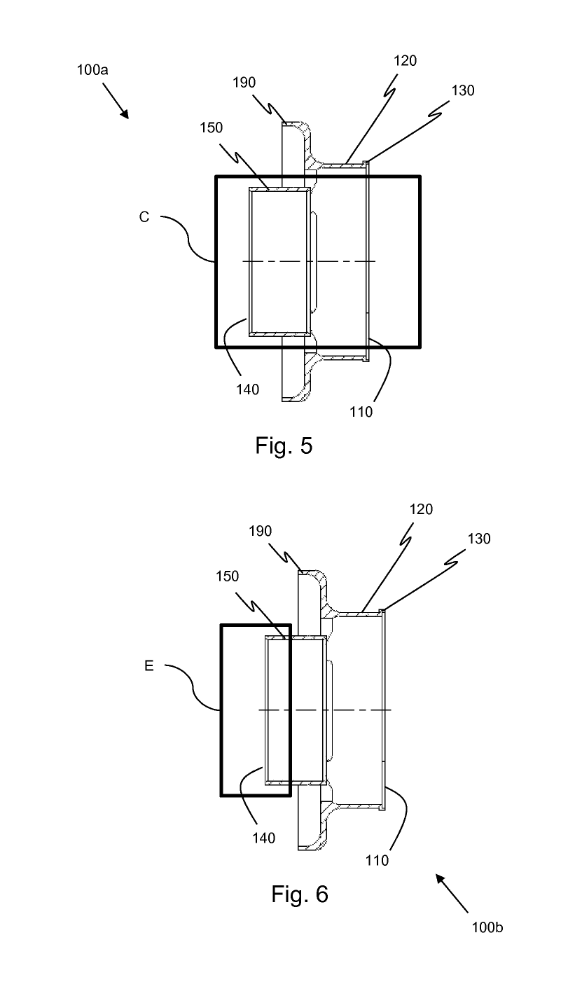

FIG. 5 illustrates a cross section of one embodiment of an adapter 100a constructed of a bimetallic rod. In the illustrated embodiment, the central portion C is constructed of a first metal, such as stainless steel, and the remaining portion is constructed of another metal, such as aluminum, titanium, or a composite material.

FIG. 6 illustrates a cross section of one embodiment of an adapter 100b constructed of a bimetallic block. In the illustrated embodiment, an end portion E is constructed of a first metal, such as stainless steel, and the remaining portion is constructed of another metal, such as aluminum, titanium, or a composite material.

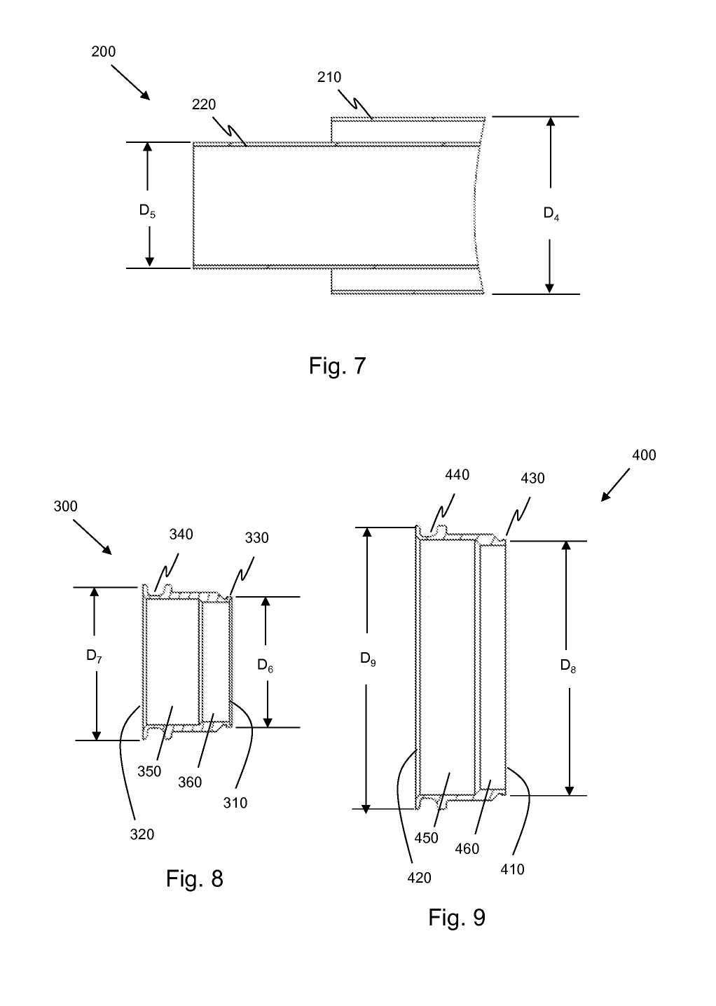

FIG. 7 illustrates a cross section of an exemplary double wall tube 200. The double wall tube 200 includes an outer tube 210 having a fourth diameter D₄ that is substantially equal to the first diameter D₁ of the large end 110 of the adapter 100. The double wall tube 200 further includes an inner tube 220 having a fifth diameter D₅ that is slightly less than the second diameter D₂ of the small end 140 of the adapter 100, such that the inner tube 220 may pass through the passageway defined by the inner wall 150 of the adapter 100.

In the illustrated embodiment, the inner tube 220 extends further than the outer tube 210. The outer tube 210 may be trimmed to a desirable length to receive the adapter 100.

In the illustrated embodiment, the outer tube 210 is substantially coaxial with the inner tube 220. The outer tube 210 may be connected to the inner tube 220 by one or more webs (not shown). Additionally, a sleeve (not shown) or fill material (not shown) may be disposed between the outer tube 210 and the inner tube 220. In an alternative embodiment (not shown), the inner tube 220 is offset from the axis of the outer tube 210.

In one known embodiment, the double wall tube 200 is constructed of steel. In alternative embodiments, the double wall tube may be constructed of titanium, aluminum, copper, or any other metal. In another alternative embodiment, the double wall tube may be constructed of a ceramic or polymeric material. In yet another alternative embodiment, the double wall tube may be constructed of a plurality of materials. For example, the inner tube may be constructed of steel and the outer tube may be constructed of aluminum. It should be understood that any combination of materials may be used in the double wall tube 200.

FIG. 8 illustrates a cross section of an inner ferrule 300. The inner ferrule 300 has a first end 310 having a sixth diameter D₆ that is substantially the same as the fifth diameter D₅ of the inner tube 220 of the double wall tube 200. The inner ferrule 300 also has a second end 320 that has a seventh diameter D₇.

The first end 310 is configured to be connected to an end of the inner tube 220 of the double wall tube 200. In the illustrated embodiment, the first end 310 includes a rim 330. In an alternative embodiment (not shown), the first end is smooth. In another alternative embodiment, the first end of the inner ferrule is configured to be connected to the inner wall of the adapter.

The second end 320 of the inner ferrule 300 includes an external groove 340. In an alternative embodiment (not shown), the second end is smooth. In another alternative embodiment (not shown), the inner ferrule 300 includes an axial face seal. In yet another alternative embodiment (not shown), the inner ferrule 300 includes a female cavity configured to receive a male end of a tube.

In the illustrated embodiment, the inner ferrule 300 includes a bore 350 and a counter bore 360 of different diameters. In an alternative embodiment (not shown), the inner ferrule may have a single bore with a single diameter. In another alternative embodiment (not shown), the inner ferrule may have a bore that is tapered or stepped. In yet another alternative embodiment (not shown), the inner ferrule may have multiple bores with three or more internal diameters.

In one known embodiment, the inner ferrule 300 is constructed of steel. In alternative embodiments, the inner ferrule may be constructed of titanium, aluminum, copper, or any other metal. In another alternative embodiment, the inner ferrule may be constructed of a ceramic or polymeric material.

FIG. 9 illustrates a cross section of an outer ferrule 400. The outer ferrule 400 has a first end 410 having an eighth diameter D₈ that is substantially the same as the third diameter D₃ of the outer flange 190 of the adapter 100. The outer ferrule 400 also has a second end 420 that has a ninth diameter D₉.

The first end 410 of the outer ferrule 400 is configured to be connected to the outer flange 190 of the adapter 100. In the illustrated embodiment, the first end 410 includes a rim 430. In an alternative embodiment (not shown), the first end is smooth.

The second end 420 of the outer ferrule 400 includes an external groove 440. In an alternative embodiment (not shown), the second end is smooth. In another alternative embodiment (not shown), the outer ferrule 400 includes an axial face seal. In yet another alternative embodiment (not shown), the outer ferrule 400 includes a female cavity configured to receive a male end of a tube.

In the illustrated embodiment, the outer ferrule 400 includes a bore 450 and a counter bore 460 of different diameters. In an alternative embodiment (not shown), the outer ferrule may have a single bore with a single diameter. In another alternative embodiment (not shown), the outer ferrule may have a bore that is tapered or stepped. In yet another alternative embodiment (not shown), the outer ferrule may have multiple bores with three or more internal diameters.

In one known embodiment, the outer ferrule 400 is constructed of steel. In alternative embodiments, the outer ferrule may be constructed of titanium, aluminum, copper, or any other metal. In another alternative embodiment, the outer ferrule may be constructed of a ceramic or polymeric material.

The adaptor 100 may be compatible with a plurality of commercially available ferrules and end interfaces. In one embodiment, inner ferrule 300 and outer ferrule 400 are of male welded ferrule with radial seal AS5830 dimension. In alternative embodiments, female ferrules or swaged ferrules may be employed. Exemplary ferrules include, without limitation, AS1730 and AS1650.

In an exemplary embodiment, the inner ferrule 300 and outer ferrule 400 are from a same series of commercially available ferrules, but have different diameters. It is anticipated that a commercially available ferrule of a first size may be employed as an inner ferrule for a large joint assembly, or as an outer ferrule for a small joint assembly. In one embodiment, the inner ferrule 300 and the outer ferrule 400 are constructed of similar materials connected by adapter 100. In an alternative embodiment, the inner ferrule and the outer ferrule may be constructed of different materials connected by the adapter.

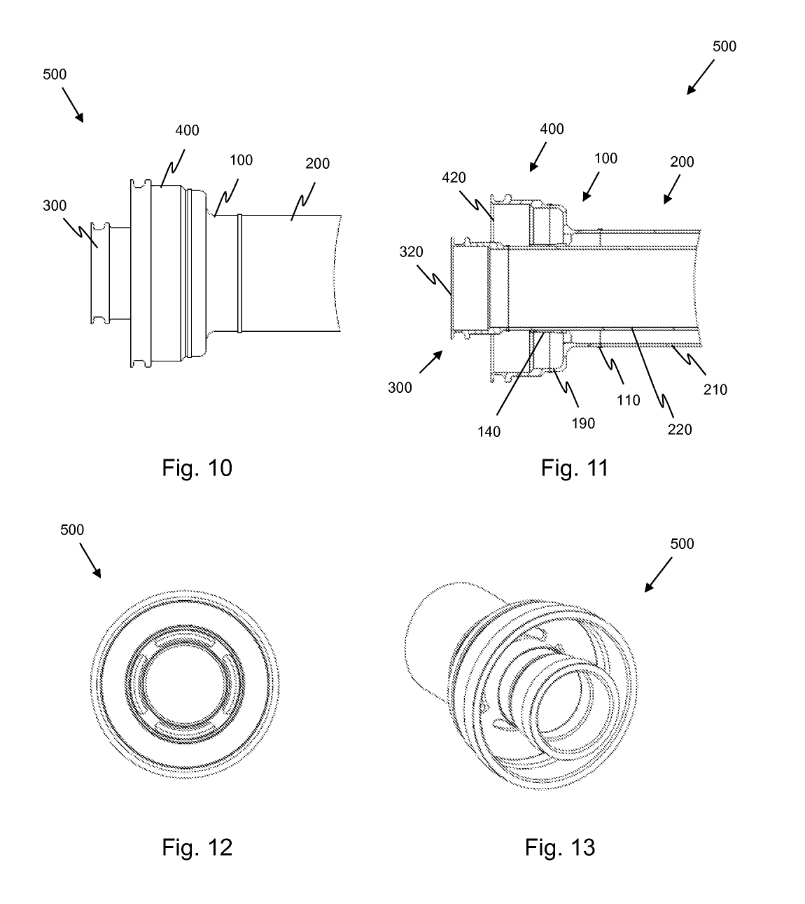

FIGS. 10 and 11 illustrate a side view and cross section, respectively, of a partial joint assembly 500 of a double wall tube. FIGS. 10 and 11 illustrate front and perspective views, respectively, of the partial joint assembly 500. The partial joint assembly 500 is described herein with reference to all of FIGS. 10-13.

In the illustrated embodiment, the double wall tube 200 is connected to the adapter 100 and to the inner ferrule 300. In addition, the adapter 100 is connected to the outer ferrule 400.

In an exemplary method of assembling the partial joint assembly 500, the outer tube 210 of the double wall tube 200 is trimmed to a desired length and planar or perpendicular alignment. The inner tube 220 of the double wall tube 200 then passes through the inner wall 150 of the adapter until the outer tube 210 butts against the large end 110 of the adapter 100. The rim 130 of the outer wall 120 of the adapter 100 acts to align and self fixture the adapter 100 to the outer tube 210.

The outer tube 210 is then butt welded to the large end 110 of the adapter 100. In an alternative embodiment, the outer tube 210 of the double wall tube 200 may slide into the outer wall 120 of the adapter 100, and the large end 110 may be fillet welded to the outer tube 210. In another alternative embodiment, the outer tube 210 may be joined to the large end 110 of the adapter 110 by adhesive or by a fastener. In yet another alternative embodiment, the outer tube 210 may be joined to the large end 110 of the adapter 100 by a threaded connection or by a friction fit. In still another alternative embodiment (not shown), the outer tube and the large end of the adapter may be mechanically swaged or crimped together.

The inner tube 220 of the double wall tube 200 is then joined to the inner wall 150 of the adapter 100. In one embodiment, the small end 140 of the adapter is fillet welded to the inner tube 220. In an alternative embodiment, the small end 140 of the adapter 100 is affixed to the inner tube 220 by adhesive or by a fastener. In another alternative embodiment, the small end 140 of the adapter 100 is joined to the inner tube 220 by a friction fit. In still another alternative embodiment (not shown), the inner tube and the small end of the adapter may be mechanically swaged or crimped together.

Because both the outer tube 210 and the inner tube 220 of the double wall tube 200 are joined to the adapter 100, the adapter 100 may maintain the inner tube 220 in a coaxial relationship with the outer tube 210.

The inner tube 220 of the double wall tube 200 may then be trimmed to a desired length and planar or perpendicular alignment. The ability to adjust the tube in three dimensions at multiple stages helps reduce or eliminate tolerance stack and absorb weld drawbacks.

The inner ferrule 300 is then joined to the end of the inner tube 220 of the double wall tube 200. In one embodiment, the inner ferrule 300 is butt welded to the end of the inner tube 220. In an alternative embodiment, the inner tube 220 of the double wall tube 200 may slide into the inner ferrule 300, and the inner ferrule 300 may be fillet welded to the inner tube 220. In another alternative embodiment, the inner tube 220 may be joined to the inner ferrule 300 by adhesive or by a fastener. In yet another alternative embodiment, the inner tube 220 may be joined to the inner ferrule 300 by a threaded connection or by a friction fit. In still another alternative embodiment (not shown), the inner tube and the inner ferrule may be mechanically swaged or crimped together. In yet another alternative embodiment, the inner ferrule 300 may be joined directly to the small end 140 of the adapter, using one of the methods described above.

The outer flange 190 of the adapter 100 may then be trimmed to a desired length and planar or perpendicular alignment. The outer ferrule 400 is then joined to the outer flange 190. In one embodiment, the inner ferrule 300 is butt welded to the end of the inner tube 220. In an alternative embodiment, the outer flange 190 of the adapter 100 may slide into the outer ferrule 400, and the outer ferrule 400 may be fillet welded to the outer flange 190. In another alternative embodiment, the outer flange 190 may be joined to the outer ferrule 400 by adhesive or by a fastener. In yet another alternative embodiment, the outer flange 190 may be joined to the outer ferrule 400 by a threaded connection or by a friction fit. In still another alternative embodiment (not shown), the outer flange of the adapter and the outer ferrule may be mechanically swaged or crimped together.

It should be understood that the above described method of assembly is merely exemplary, and that the steps may be performed in a different order. Additionally, a sealant may be applied to the assembly. In one known example, LOCTITE 5421 Conductive RTV sealant is applied. Alternatively, a preformed sleeve or bushing may be employed instead of sealant.

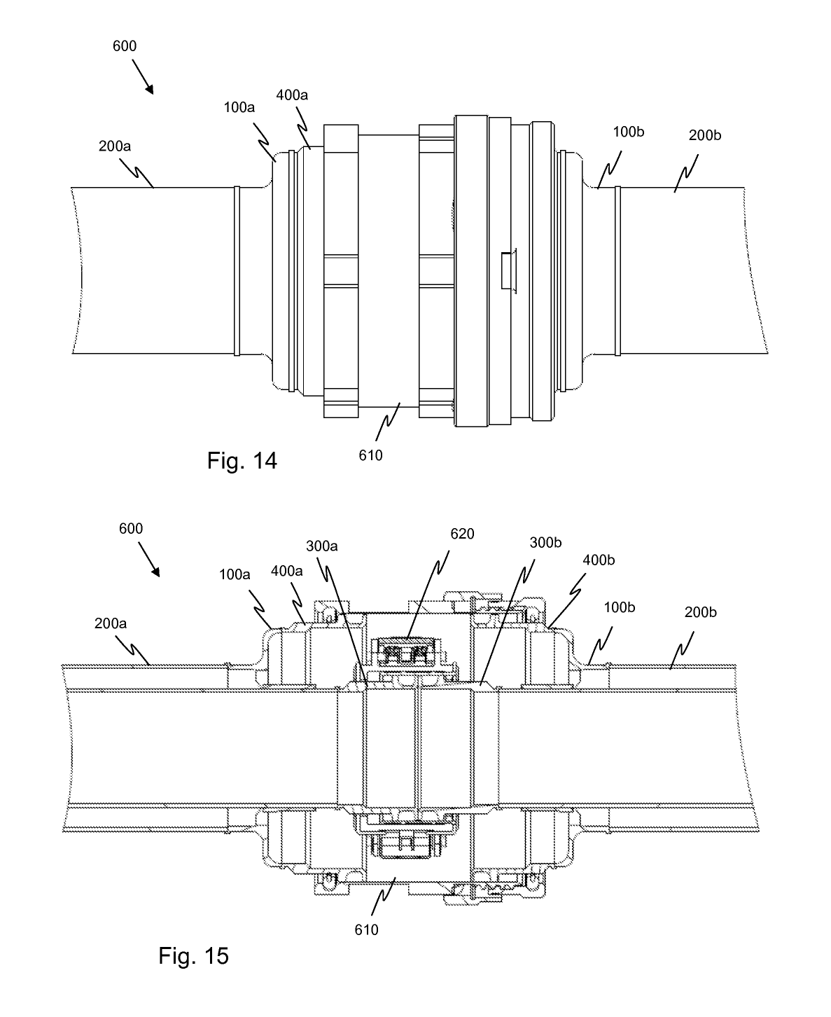

The partial joint assembly 500 may be connected to a conduit or to another partial joint assembly. FIGS. 14 and 15 illustrate a side view and cross section of a joint assembly 600 in which a first partial joint assembly 500a is connected to a second partial joint assembly 500b by a shroud 610.

The first partial joint assembly 500a includes a first adapter 100a, a first double wall tube 200a, a first inner ferrule 300a, and a first outer ferrule 400a assembled in the manner described above. The second partial joint assembly 500b includes a second adapter 100b, a second double wall tube 200b, a second inner ferrule 300b, and a second outer ferrule 400b assembled in the manner described above.

After the first and second partial joint assemblies 500a,b are assembled, they are joined at the first and second inner ferrules 300a,b and affixed by a clamp 620. The first and second outer ferrules 400a,b are then joined by the shroud 610. The shroud 610 may be connected to the outer ferrules 400a,b by a nut and retainers.

Because each partial joint assembly 500 is comprised of an adapter 100 and separate inner and outer ferrules 300, 400, a single adapter 100 may be connected to different sized shrouds 610 through different outer ferrules 400. Therefore, the adapter 100 may be described as a universal adapter.

In one embodiment, the adapter 100, inner ferrule 300, outer ferrule 400, shroud 610, and clamp 620 are constructed of the same material. In an alternative embodiment, one or more of the adapter 100, 100a, 100b, inner ferrule 300, outer ferrule 400, shroud 610, and clamp 620 are constructed of different materials.

As one of ordinary skill in the art would understand, the above described joint assemblies and partial joint assemblies allow for electrical bonding between the inner tube and outer tube of the double wall tube.

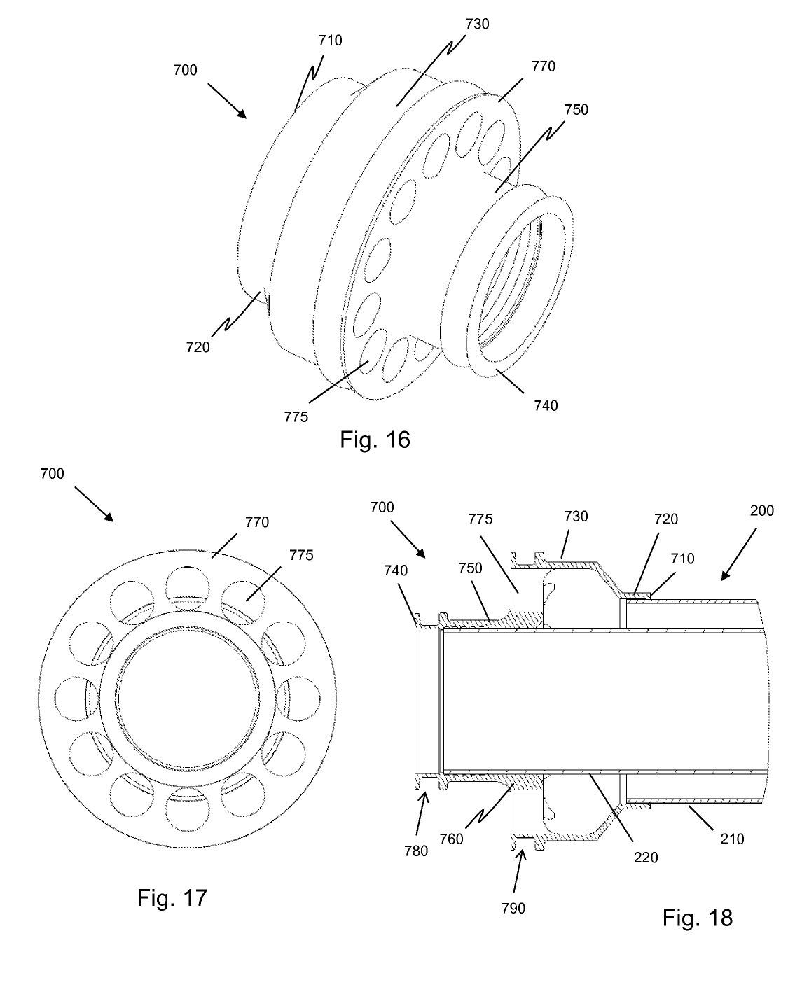

FIG. 16 is a perspective view of an alternative embodiment of a double wall tube adapter 700. FIGS. 17 and 18 illustrate a front view and cross section, respectively, of the adapter 700. The adapter 700 will be described with reference to all three figures. The adapter 700 may be referred to as a mono-detail double wall tube adapter, because it uses only a single adapter instead of a three-part assembly having a tube-to-tube adapter and two ferrules.

The adapter 700 has a large end 710 defined by an outer wall 720 that flares outwardly to a large diameter portion 730. The large end 710 is configured to receive an outer tube 210 of a double wall tube assembly 200. The adapter 700 may be slid over the outer tube 210 and fillet welded.

The adapter 700 also has a small end 740 defined by an inner wall 750. The inner wall 750 is configured to receive an inner tube 210 of a double wall tube 200. The inner tube may be swaged or welded to the inner wall 750. The inner wall 750 terminates at an inner end 760. The large diameter portion 730 is connected to the inner wall 750 by a web 770. The web 770 includes a plurality of vents 775. In the illustrated embodiment, the vents 775 are substantially circular. However, it should be understood that the vents may be elongated, similar to the elongated vents 180 of adapter 100 shown in FIG. 1. Alternatively, the vents may be square, triangular, or have any geometric shape.

As discussed above, the adapter 700 does not require ferrules. Instead, the small end 740 includes an external groove 780 and the large diameter portion also includes an external groove 790. The external grooves 780, 790 may receive fasteners in the same manner described above with respect to FIG. 15.

In one known embodiment, the adapter 700 is constructed of steel. In alternative embodiments, the adapter may be constructed of titanium, aluminum, copper, or any other metal. In another alternative embodiment, the adapter may be constructed of a ceramic or polymeric material.

In one particular embodiment, the adapter 700 is manufactured from a bimetallic block or a bimetallic rod. The bimetallic block can be manufactured by explosion welding two or more sheets or blocks of metal together, such as a block of aluminum to a block of steel. In an alternative embodiment, the bimetallic block or rod can be manufactured by friction welding two or more sheets or blocks of metal together, such as a block of aluminum to a block of steel. The materials may be selected to correspond to the materials of a double wall tube, thereby allowing the outer wall of the adapter to be welded to an outer wall 220 of a double wall tube assembly 200, and further allowing the inner wall of the adapter to be welded to an inner wall 210 of a double wall tube assembly 200.

In the bimetallic block or bimetallic rod, transition layers of dissimilar metals, such as tantalum, titanium, or copper may be used between the aluminum and steel layers. The transition layers provide barrier between dissimilar metals that prevent galvanic corrosion and improve the strength of the resulting explosion welded material. It should be understood that many other combinations of materials are possible.

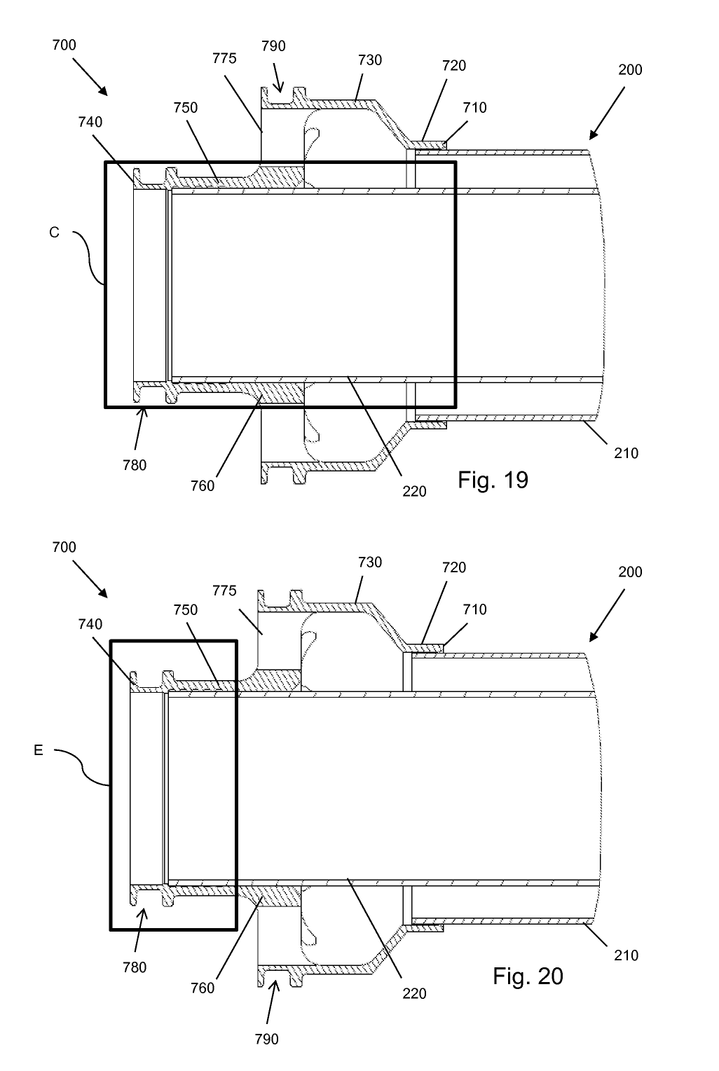

FIG. 19 illustrates a cross section of one embodiment of an adapter 700a constructed of a bimetallic rod. In the illustrated embodiment, the central portion C is constructed of a first metal, such as stainless steel, and the remaining portion is constructed of another metal, such as aluminum, titanium, or a composite material.

FIG. 20 illustrates a cross section of one embodiment of an adapter 700b constructed of a bimetallic block. In the illustrated embodiment, an end portion E is constructed of a first metal, such as stainless steel, and the remaining portion is constructed of another metal, such as aluminum, titanium, or a composite material

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A joint for a double wall tube assembly, the joint comprising:
an adapter having an inner wall and an outer wall connected by a web, and a flange extending from the outer wall,
wherein the inner wall is configured to receive an inner tube of the double wall tube assembly, and
wherein the outer wall is configured to be connected to an outer tube of the double wall tube assembly.

2. The joint of claim 1, further comprising an inner ferrule connected to the inner tube of the double wall tube assembly.

3. The joint of claim 2, further comprising an outer ferrule connected to the flange of the adapter.

4. The joint of claim 1, wherein an outer portion of the adapter is constructed of a first metal, and an inner portion of the adapter is constructed of a second metal different from the first metal.

5. The joint of claim 1, wherein a left end of the adapter is constructed of a first metal, and a right end of the adapter is constructed of a second metal different from the first metal.

6. The joint of claim 1, wherein the web includes a plurality of vents.

7. The joint of claim 1, wherein the inner wall of the adapter has a groove disposed thereon and the flange has a groove disposed thereon.

8. An adapter for a double wall tube assembly, the adapter comprising:
a first end defined by a first wall having a first diameter, wherein the first wall is configured to receive an inner tube of a double wall tube assembly;
a second end defined by a second wall having a second diameter greater than the first diameter, wherein the second wall is configured to be connected to an outer tube of the double wall tube assembly, wherein the second wall flares outward towards the first end, thereby defining a third diameter portion, and wherein the third diameter is greater than the first diameter and greater than the second diameter; and
a web connecting the first wall to the second wall.

9. The adapter of claim 8, wherein the web includes a plurality of vents.

10. The adapter of claim 8, wherein the first wall includes an external groove disposed thereon.

11. The adapter of claim 8, wherein the third diameter portion includes an external groove disposed thereon.

12. The adapter of claim 8, wherein the adapter is constructed of a first material explosion welded to a second material.

13. The adapter of claim 8, wherein the adapter is constructed of a first material friction welded to a second material.

14. A method of joining a double wall tube assembly to a joint, the method comprising:
providing an adapter having an inner wall, an outer wall, and a flange extending from the outer wall, with a webbing connecting the inner wall to the outer wall;
connecting an inner tube of the double wall tube assembly to the inner wall of the adapter; and
connecting an outer tube of the double wall tube assembly to the outer wall of the adapter.

15. The method of claim 14, wherein the providing an adapter includes one of explosion welding and friction welding a first material to a second material, and forming the adapter from the welded materials.

16. The method of claim 14, wherein the connecting the inner tube of the double wall tube assembly to the inner wall of the adapter includes welding the inner tube of the double wall tube assembly to the inner wall of the adapter.

17. The method of claim 14, wherein the connecting the inner tube of the double wall tube assembly to the inner wall of the adapter includes swaging the inner tube of the double wall tube assembly to the inner wall of the adapter.

18. The method of claim 14, wherein the connecting the outer tube of the double wall tube assembly to the outer wall of the adapter includes welding the outer tube of the double wall tube assembly to the outer wall of the adapter.

19. The method of claim 14, further comprising connecting a ferrule to the inner tube of the double wall tube assembly.

20. The method of claim 14, further comprising connecting a ferrule to the flange of the adapter.
